(19) United States
(12) Patent Application Publication
(10) Pub. No.: US 2008/0139372 A1
(43) Pub. Date: Jun. 12, 2008

(54) PROCESS AND MACHINE FOR BLANK FOLDING

(76) Inventors: Lionel CAILLOUX, Thonon Les Bains (FR); Roger DUPERTUIS, La Praz (CH)

Correspondence Address: OSTROLENK FABER GERB & SOFFEN, 1180 AVENUE OF THE AMERICAS, NEW YORK, NY, 100368403, US

(21) Appl. No.: 11/936,355

(22) Filed: Nov. 7, 2007

(30) Foreign Application Priority Data
Dec. 11, 2006 (EP) 06025554.4

(51) Int. Cl. B31B 1/26; B31B 5/00

(52) U.S. Cl. 493/131; 493/178; 493/138

(57) ABSTRACT

Folding process of a blank of paper, cardboard, plastic, corrugated board or similar material used to carry out a folded box, the blank comprising a left longitudinal edge, a right longitudinal edge and from left to right, at least two respective longitudinal grooves delimitating at least two respective adjacent panels, the process comprising at least the successive following steps: a) folding at 180° of the panel around the longitudinal groove into a first folding device and formation of a longitudinal fold along the groove b) aligning of the said blank along the longitudinal fold into a main aligning device c) folding at 180° of the panel around the groove into a second folding device.

### TECHNICAL FIELD

The present invention relates to a folding process of a blank of paper, cardboard, plastic, corrugated board or similar material used to carry out a folded box.

The present invention also relates to a machine for applying the folding process according to the invention.

### BACKGROUND ART

To carry out a folded box of a given material, it is known to convert a blank of said material using a machine called <<folder-gluer>>. For instance, to carry out a parallelepiped box, i.e. a box with a rectangular bottom, the suitable blank has the general shape of a rectangle with two lateral sides and two transverse sides.

With regard to the running direction of the blanks in the folder-gluer, the front edge of the blank is the transverse side which first enters into the machine and the rear side the one which last enters. As well as the left edge of the blank is the lateral side of the blank located at the left side of the longitudinal axis of the folder-gluer and the right edge is the lateral side of the blank located at the right side of the longitudinal axis of the folder-gluer. In order to correctly fold the blank of a rectangular bottom box (also called standard box), the blank comprises four longitudinal grooves (or scorings) from left to right which divide the blank into five parts: four adjacent panels and one glue flap. For a box with a biconvex bottom or an envelope, the blank comprises two longitudinal grooves which divide the blank in three parts: two adjacent panels and one glue flap.

For achieving a folded box, the panels located at the left and right edges of the blank are folded down at 180° toward the inside of the blank. In the latter position, the distance between the right and left edges of the blank is called the gap. If necessary, we will make a distinction between the gap at the front of the folded box and the gap at the rear of the folded box.

To carry out a faultless folded box, the gap of the folded box must be equal to a reference gap Gref set by specifications. Now in the practice, we observe that it is very difficult to ensure this equality for all the boxes of a same production. This is the reason why we accept that the gap of a folded box can be equal to Gref+Δ, at condition that Δ is as small as possible. Δ symbolizes the gap difference with respect to the reference gap, Δ can be positive or negative.

A faultless folded box is also a box wherein the front gap is equal to the rear gap because otherwise the folded box will have the shape of a trapezoid. This problem is known under the name of “fishtailing”.

A first known folding process consists of the simultaneous folding down at 180° of the edge panels. This folding process does neither allow to reduce the gap Δ, nor to avoid the fishtailing.

Another known process (see FIGS. 5a and 5b) consists to fold down successively at 180° the panels located at the right and left edges of the blank. This folding process does not better allow to reduce the gap Δ or to avoid the fishtailing.

In the aforesaid background art, it is also known to align the left or right edge of the blank along an axis parallel to the longitudinal axis of the folder-gluer before folding down the panels located at the right and left edges of the blank.

### Disclosure Of Invention

A first aim of the present invention is to minimize the difference of gap Δ. To that end, the present invention consists of a folding process according to claim 1.

Another object of the invention is to suppress or, at least, to reduce the fishtailing. Further characteristics and advantages of the present invention will become better apparent from the following description of particular embodiments thereof, illustrated only by way of non-limitative examples in the accompanying drawings.

### BRIEF DESCRIPTION OF FIGURES IN THE DRAWINGS

FIG. 1 is a simplified elevation view of a first embodiment of a folder-gluer suitable to apply the process according to the invention;

FIG. 2 is a simplified elevation view of a second embodiment of a folder-gluer suitable to apply the process according to the invention;

FIG. 3 is a view of a box in process;

FIG. 4 is a view of a folded box;

FIGS. 5a and 5b show folding steps according to the background art;

FIG. 6a to 6c show folding steps according to the invention;

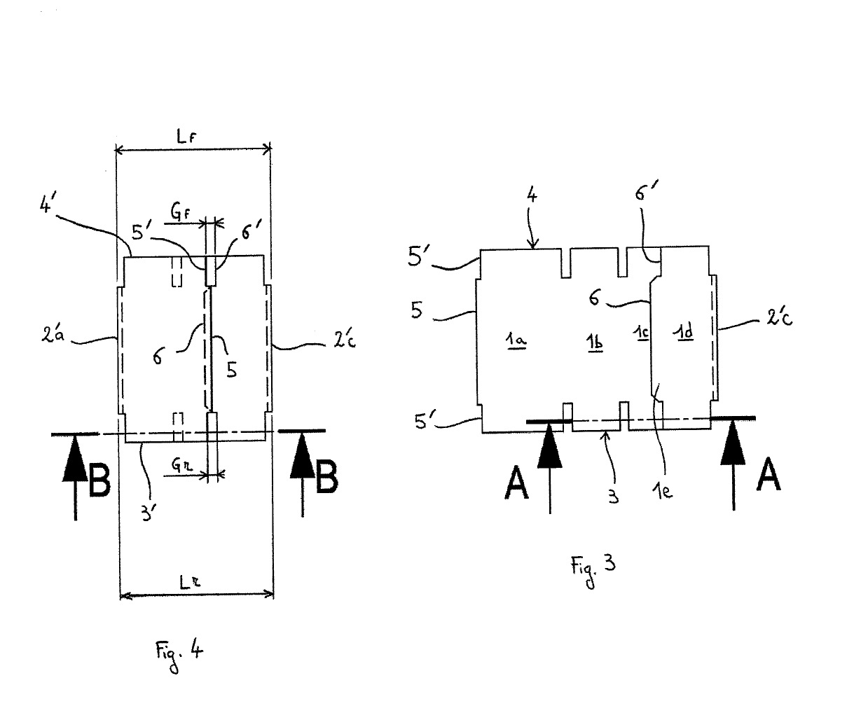

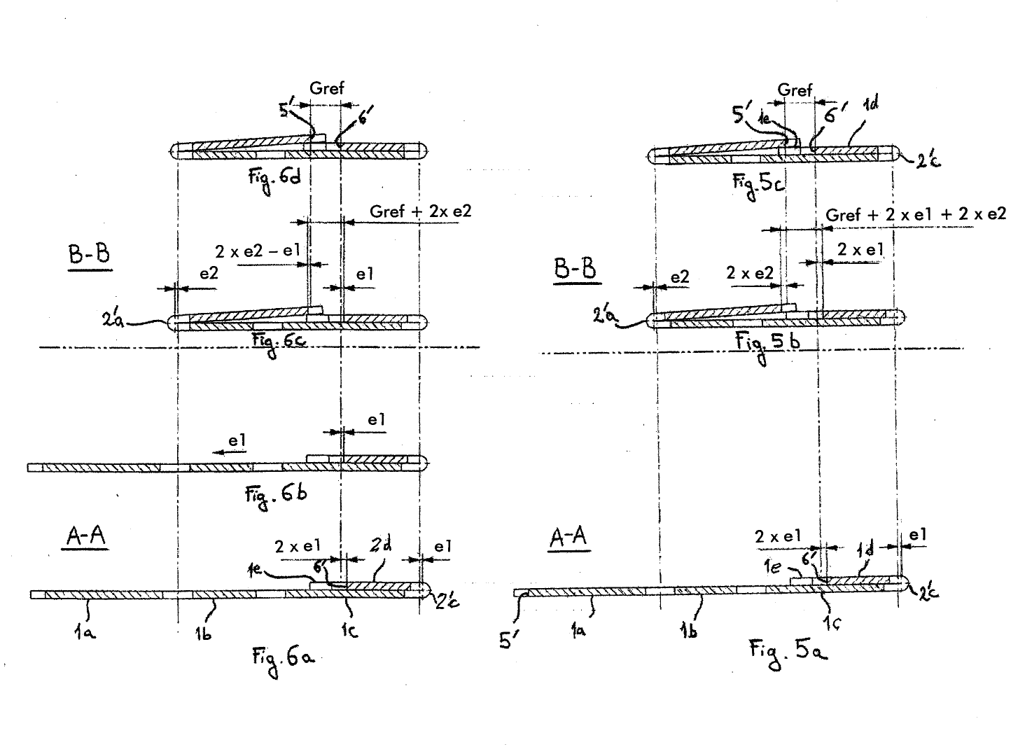

FIGS. 5c and 6d show a reference folded box.

### BEST MODE FOR CARRYING OUT THE INVENTION

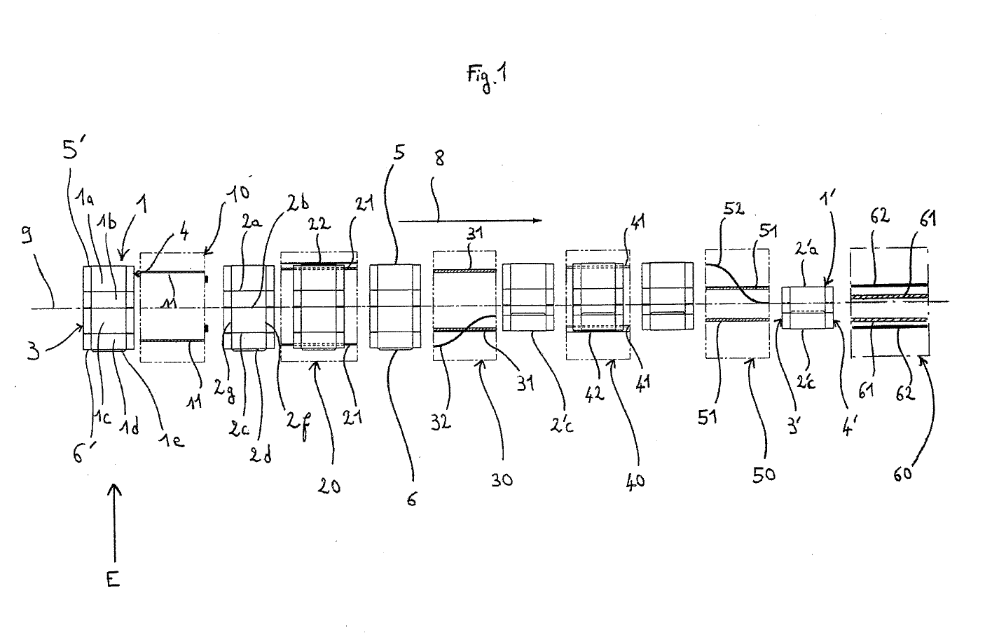

FIG. 1 illustrates schematically a first embodiment of a folder-gluer suitable to apply the process according to the invention, FIG. 1 also illustrates different steps of the folding process of a blank 1. In the example, the blank 1 is meant to carry out a standard box. The arrow 8 indicates the running direction of the blanks in the folder-gluer, this direction is parallel to the longitudinal axis 9 of the folder-gluer. Next, the folder-gluer plane is defined as being the horizontal plane passing by the longitudinal axis of the folder-gluer.

Each blank entering at entry E of the folder-gluer has a general shape of a rectangle with two lateral sides 5 and 6, parallel to the longitudinal axis of the folder-gluer and two transverse sides 3 and 4, perpendicular to the longitudinal axis of the folder-gluer, in the plane of it. With regard to the running direction of the blanks, we define the transverse side 3 as being the rear edge of the blank and the transverse side 4 as being the front edge of the blank, as well as the lateral side 5 is defined as being the left edge of the blank and the lateral side 6 as being the right edge of the blank. At last, we define the length of the blank as being the distance between the front edge and the rear edge of the blank.

In order to be folded at the right places, the blank 1 includes, from left to right, four longitudinal grooves (or scorings) respectively 2a, 2b, 2c and 2d, parallel to the left edge 5 and which delimitate four adjacent panels respectively 1a, 1b, 1c and 1d. In order to later allow the shaping of the bottom and the lid of the box, transverse grooves 2f and 2g, parallel to the front edge respectively rear edge of the blank, are foreseen at distance of the said edges. As well as slits are foreseen in the continuation of the grooves 2a, 2b and 2c between the said transverse grooves 2f and 2g and the said front edge respectively rear edge of the blank.

Each panel has the general shape of a rectangle with two lateral sides and two transverse sides which coincide with the rear edge 3 and the front edge 4 of the blank. The lateral sides of the first panel 1a coincide with the left edge 5 of the blank and the longitudinal groove 2a. The lateral sides of the second panel 1b coincide with the longitudinal grooves 2a and 2b. The lateral sides of the third panel 1c coincide with the longitudinal grooves 2b and 2c. Whereas the lateral sides of the forth panel 1d coincide with the lateral grooves 2c and 2d. The groove 2d separates the forth panel 1d of a glue flap 1e delimitated by said groove 2d and the right edge 6. In variation, the glue flap 1e can be adjacent to the first panel 1a.

In the first embodiment of the machine illustrated at FIG. 1, a blank 1 is conveyed by a conveyor 11 from a feeder 10. Afterwards, a feeder 31 conveys the said blank in a first folding device 30. In the folding device 30, the panel 1d, is folded down onto the panel 1c with the help of a folding blade 32, in other words the panel 1d is folded at 180° around the groove 2c. At the end of this first folding operation, a first longitudinal fold 2′c appears at the place of the groove 2c. Afterwards, a conveyor 41 conveys the said blank into a main aligning device 40. In the aligning device 40, the first longitudinal fold 2′c of the blank 1 comes into linear contact with a rule 42 (or guiding rail), along it. In the plane of the folder-gluer, the longitudinal axis of the rule 42 forms with the longitudinal folder-gluer axis a null angle, in other words, the longitudinal axis of the rule 42 is parallel to the longitudinal axis of the folder-gluer, so as the groove 2a is parallel to the longitudinal axis of the folder-gluer. Thanks to these arrangements, every error during the first folding operation is compensated before the second folding operation in order to minimize the difference of gap Δ. Please refer to the description of FIGS. 6a to 6c for a detailed explanation.

Afterwards, a conveyor 51 conveys the said blank in a second folding device 50. In the folding device 50, the panel 1a is folded down onto the panel 1b by using a folding blade 52, in other words the panel 1a is folded at 180° around the groove 2a. At the end of this second folding operation, a second longitudinal fold 2′a appears at the place of the groove 2a. Upstream the second folding operation, the glue flap 1e is glued so that at the end of the folding operation, the panel 1a is glued to the glue flap 1e, the panels 1a and 1d are then adjacent. The folded box 1′ which has been so far achieved has ideally the shape of a rectangle with two lateral sides coinciding with the folds 2′a and 2′c, and two transverse sides 3′ and 4′ corresponding respectively to the rear 3 and the front 4 edges of the blank. In the example, the respective folding blade 32, 52 is made of a synthetic material representing a stick following a curve of which torsion is proportional to the curve, the blade axis coinciding with the folding axis.

In some cases, the blank 1 exiting from the feeder 10 is not correctly positioned for the folding operation, it is then advantageous to let the blank go first trough an auxiliary aligning device 20 before going through the first folding device 30. To this end, the blank exiting from the feeder 10 is conveyed by a conveyor 21 into the auxiliary aligning device 20. In the auxiliary aligning device 20, the left edge 5 of the blank 1 comes into linear contact with a rule 22 (or guiding rail), along it. In the folder-gluer plane, the longitudinal axis of the rule 22 forms with the longitudinal axis of the folder-gluer a null angle, in other words, the longitudinal axis of the rule 22 is parallel to the longitudinal axis of the folder-gluer, so that the groove 2c is parallel to the longitudinal axis of the folder-gluer.

Advantageously, the folded box 1′ exiting from the second folding device 50 is conveyed by conveyor 61 into a calibrating device 60. In the calibrating device 60, the folded box 1′ goes between two longitudinal bars 62. The distance between the bars 62 is equal to the width of a reference folded box. Thereby when the folded box which enters into the calibrating device has a width bigger than the reference width, the box is pressed on his lateral sides 2′a and 2′c by the bars 62. The action of the bars 62 has the effect to put the reference size to the width of the folded box. A reference folded box is a box with dimensions corresponding to the dimensions set by the specifications of the box. The width of the folded box corresponds to the distance separating the lateral side 2′a from the lateral side 2′c. If necessary we will make a distinction between the width Lf at the front of the folded box and the width Lr at the rear of the folded box (see FIG. 4). The width, Lf is the distance separating the lateral side 2′a from the lateral side 2′c, of the transverse side 4′, whereas the width Lr is the distance separating the lateral side 2′a from the lateral side 2′c, of the transverse side 3′. The bars 62 can be made of rollers tracks (not shown).

Also advantageously, supporting means (not represented) are foreseen into the calibrating device 60 in order to apply a vertical pressure on the panel 1a, at the place on which the panel is in contact with the glue flap 2d, this allows a better setting of the glue. By this way, the folded boxes exiting from the calibrating device 60 are ready to be conditioned, for example, they can be transferred to a delivery station where they will be collected in order to be stored in piles on a pallet or loaded into a container.

FIG. 2 shows a second embodiment of a folder-gluer suitable to apply the process according to the invention. In this variant, we keep all the elements of FIG. 1 as well as all the steps of the process, just the angles value changes. The numbering of the elements of FIG. 1 has therefore been kept.

In this second embodiment of the folder-gluer, the longitudinal axis of the rule 22 forms with the longitudinal axis of the folder-gluer a non-null angle α, so that the blank 1 exiting from the auxiliary aligning device 20 is staggered by an angle α with respect to the running direction of the blank. As well as the longitudinal axis of the rule 42 forms with the longitudinal axis of the folder-gluer a non-null angle β, so that the blank exiting from the main aligning device 40 is staggered by an angle β with respect to the running direction of the blank. By this way, we intend to solve the fishtailing problem.

Usually, in order to completely avoid the fishtailing, the panel 1d must be folded at 180° around the longitudinal groove 2c by a bending force applied simultaneously on at least to points, a first point near the front edge 4 of the blank and, a second point near the rear edge 3 of the blank. If the bending force is applied on only one point, it is still possible to avoid the fishtailing by placing said point somewhere along the median axis of the panel 1d. But, if the only point of contact is elsewhere than on the median axis of the blank 1d, the fishtailing problem is difficult to avoid. The median axis of the panel 1d is herewith defined as being the parallel axis of the rear edge or the front edge of the blank located at equal distance of said front and rear edges.

When the blank 1 arrives at the entry of the first folding device 30, the panel 1d is conveyed by its front edge 4 in a folding blade 32. During the running of the blank, the blade 32 applies to the panel 1d a bending force which applies to the front edge 4. This bending force tends to angularly stagger the folding axis (or rotation axis) of the panel with respect to the axis of the longitudinal groove 2c, in the folder-gluer plane. Such an offset generates fishtailing.

To solve this problem, in the second embodiment of the folder-gluer, the blank which comes at the entry of the first folding device 30 is staggered by an angle α with respect to the running direction of the blank, the angle α is selected for corresponding to the offset of the folding axis. By this way, the axis of the longitudinal groove 2c coincides with the folding axis of the panel 1d, so that the 180° folding of the panel 1d is correctly done around the longitudinal groove 2c.

The problem we encounter for the folding of the panel 1d is the same problem posed for the folding of the panel 1a. Actually, when the blank 1 arrives at the entry of the second folding device 50, the panel 1a is conveyed by its front edge 4 in a folding blade 52. During the running of the blank, the blade 52 applies to the panel 1a a bending force which applies to the front edge 4. This bending force tends to angularly stagger the folding axis (or rotation axis) of the panel with respect to the axis of the longitudinal groove 2a in the plane of the folder-gluer. This offset generates fishtailing.

In order to solve this problem, in the second embodiment of the folder-gluer, the blank arriving at the entry of the second folding device 50 is staggered by an angle β with respect to the running direction of the blank, the angle β is chosen for corresponding to the offset of the folding axis. By this way, the axis of the longitudinal groove 2a coincides with the folding axis of the panel 1a, so that the 180° folding of the panel 1a is correctly done around the longitudinal groove 2a.

Thanks to these arrangements, the gap at the front of the folded box is equal to the gap at the rear of the box, in other words, the folded box has the shape of a rectangle, the fishtailing problem has been solved.

Regarding the offset value of the folding axis, it depends of several different parameters, as for example, the size of the panels to be folded, the blank material, its thickness, the depth and the length of the grooves around which the panels will be folded, the length of the blades. Reason why, it is very difficult to foresee the offset before the folding of a blank. Consequently, the angles α and β are chosen in function of the noticed offset. For example, if we notice for a given blank that the offset of the folding axis in the first and second folding devices is +2° and −2° respectively, therefore the angles α and β are chosen equal to +2° and −2 respectively.

In the example of FIGS. 1 and 2, the upper parts of the conveyors 11, 21, 31, 41, 51 and 61 have not been represented, only the lower parts are shown. The conveyors can be of belts or rollers type. The conveyors 11 and 21 can be gathered in a common conveyor, as well as the conveyors 51 and 61. Also, the second folding device 50 and the calibrating device 60 can be gathered in a common device.

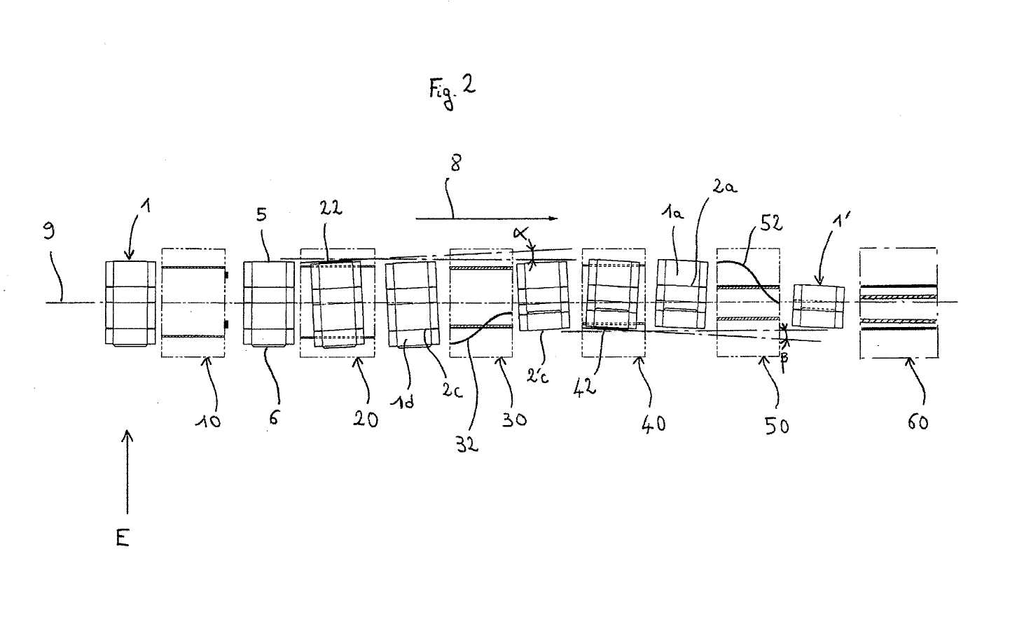

FIG. 3 shows a blank at the output of the first folding device 30 (the grooves have not been represented). At this step of the process according to the invention, the panel 1d is folded down onto the panel 1c. On this figure we can also see that the left edge 5 of the blank doesn't spread over the entire length of the blank. The edge 5 has a setback (i.e. horizontal offset) 5′ between the transverse grooves 2f and 2g and the respective front and rear edges of the blank. In the example, the edge 5′ is parallel to the edge 5. Similarly, we can see that the right edge 6 of the blank doesn't spread over the entire length of the blank. The edge 6 has a setback 6′ between the transverse grooves 2f and 2g and the respective front and rear edges of the blank. In the example, the edge 6′ is parallel to the edge 6. Thanks to these arrangements, the folded box will appear with a slit in the continuation of the groove 2d between the transverse grooves 2f and 2g and the respective front and rear edges of the blank.

FIG. 4 shows a folded box, i.e. a blank at the output of the second folding device 50 (the grooves are not represented). At this step of the process according to the invention, the panel 1a is folded down onto the panel 1b and glued to the glue flap 1e so that the folded box is sealed. In this example, we have chosen to measure the gap between the edges 5′ and 6′. If necessary we will make a distinction between the gap Gf at the front of the folded box and the gap Gr at the rear of the folded box. The gap Gf is the distance separating the left edge 5′ from the right edge 6, of the transverse side 4′, whereas the gap Gr is the distance separating the left edge 5′ from the right edge 6′, of the transversal side 3′.

FIGS. 5a and 5b show a folded box issued from the process of the background art. For convenience, we will use the same numbering as the one used in relation with the folded box issued from the process according to the invention. FIG. 5a is a sectional view of a blank of the background art through line A-A of FIG. 3, FIG. 5b is a sectional view of a box of the background art through line B-B of FIG. 4. FIG. 5c shows a reference box according to a similar view as the one of FIG. 5b.

If during the folding operation at 180° of the panel 1d, the position of the rotation axis of the panel 1d is staggered by e1 with respect to the position of rotation axis of the reference box, it results in an offset of the position of the right edge 6′ equal to 2×e1 (see FIG. 5a). Similarly, if during the folding operation at 180° of the panel 1a, the position of the rotation axis of the panel 1a is staggered by e2 with respect to the one of the reference box, it results in an offset of the position of the left edge 5′ equal to 2×e2 (see FIG. 5b). Consequently, the gap resulting from the two successive foldings is equal to Gref+2×e1+2×e2, wherein Gref is the gap of a folded reference box and 2×e1+2×e2 is the difference of gap Δ (see FIG. 5c).

FIGS. 6a and 6c show the folding of a box according to the invention. FIGS. 6a and 6b are sectional views of a blank through the line A-A of FIG. 3, FIG. 6c is a sectional view through the line B-B of the box of FIG. 4. FIG. 6d shows a reference box according to a similar view as the one of FIG. 6c.

If a the end of the folding operation of panel 1d in the first folding device 30 an error e1 appears, the transit of the blank trough the main aligning device 40, before transiting through the second folding device 50, allows to compensate this error on the resulting gap. Indeed as into the main aligning device 40 the longitudinal fold 2′c of the blank comes into linear contact with the rule 42, along it, an offset e1 of the position of the fold 2′c results in an offset e1 of the position of the left edge 5′ and an offset 2×e1 of the position of the right edge 6′. For example, if the position of the rotation axis of the panel 1d is staggered by 1 mm to the right with respect to the reference box rotation axis position, the right edge 6′ is staggered by 2×1 mm to the right with respect to its reference position (see FIG. 6a). Afterwards the fact of aligning the blank along the fold 2′c results in staggering the blank by 1 mm to the left and so to stagger by 1 mm to the left the right edge 6′ and the left edge 5′ (see FIG. 6b).

In case the folding of the panel 1a occurs without any error, in other words, the position of the rotation axis of the panel 1a is not staggered with respect to the reference box rotation axis position, the folding operation at 180° of the panel 1a has the effect to reverse the offset resulting from the aligning of the blank along the fold 2′c (see FIG. 6c). But, if the position of the rotation axis of the panel 1a is staggered, for example by 1 mm to the left with respect to the reference box rotation axis position, the left edge 5′ is then staggered by −1+2×1 i.e. 1 mm to the left with respect to the reference position.

Thanks to the process according to the invention, the error e1 of the position of the rotation axis of the panel 1d is compensated before the folding operation of the panel 1a, so that the gap resulting of the two successive foldings is independent from the error e1. Usually, if at the end of the folding operation of the panel 1a in the second folding device 50 an error e2 appears (see FIG. 6c), the gap resulting from the two successive foldings is limited to Gref+2×e2, wherein Gref is the gap of a folding reference box and 2×e2 is the difference of gap Δ (see FIG. 6d).

Of course the gap is calculated the same way at the front as at the rear of the folded box.

Thanks to these arrangements, the difference of gap Δ has been minimized by passing from the value 2×e1+2×e2 in the background art to the value 2×e2 according to the invention.

The process according to the invention has been described in relation with the folding of a blank foreseen to form a standard box but it is clear that the process in question can be used for the folding of a blank foreseen to form every kind of box provided that the said blank has at last two panels to be folded.

1. Folding process of a blank of paper, cardboard, plastic, corrugated board or similar material used to carry out a folded box, the blank comprising a left longitudinal edge, a right longitudinal edge and, from left to right, at least two respective longitudinal grooves delimitating at least two respective adjacent panels, the process comprising at least the successive steps:
a) folding at 180° of the panel around the longitudinal groove into a first folding device and formation of a longitudinal fold along the groove;
b) aligning of the blank along the longitudinal fold into a main aligning device;
c) folding at 180° of the blank around the groove into a second folding device.

2. Folding process according to claim 1, including before step a), a step a′) of aligning the blank along the left edge into an auxiliary aligning device.

3. Folding process according to claim 2, wherein the aligning step a′) consists of putting the left edge of the blank into linear contact with a rule, along it.

4. Folding process according to claim 3, wherein the longitudinal axis of the rule forms a non-null angle a with respect to the longitudinal axis of the folder-gluer, in the plan of it.

5. Folding process according to claim 1, wherein the aligning step c) consists of putting the longitudinal fold of the blank into linear contact with a rule, along it.

6. Folding process according to claim 5, wherein the longitudinal axis of the rule forms a non-null angle β with respect to the longitudinal axis of the folder-gluer, in the plan of it.

7. Folding process according to claim 1, including after step c), a step d) of calibration of the folded box into a calibrating device.

8. Folding process according to claim 7, wherein the calibrating step d) consists of running the folded box between two longitudinal bars, the distance between the bars being predetermined.

9. Folder-gluer machine for applying the folding process according to claim 1, comprising from machine entry to machine exit, a first folding device, a main aligning device, a second folding device.

10. Folder-gluer machine according to claim 9, further comprising an auxiliary aligning device located before the first folding device.

11. Folder-gluer machine according to claim 9, wherein the main aligning device comprises a rule which has a longitudinal axis forming a non-null angle with respect to the longitudinal axis of the folder-gluer.

12. Folder-gluer machine according to claim 10, wherein the auxiliary aligning device comprises a rule which has a longitudinal axis forming a non-null angle with respect to the longitudinal axis of the folder-gluer.

13. Folder-gluer machine according to claim 9, further comprising a calibrating device after the second folding device.
